(19) United States
(12) Patent Application Publication
(10) Pub. No.: US 2024/0409063 A1
(43) Pub. Date: Dec. 12, 2024

(54) METHOD FOR AUTHENTICATING THE USER OF A MOTOR VEHICLE

(71) Applicant: MERCEDES-BENZ GROUP AG, Stuttgart (DE)

(72) Inventor: Tobias HUG, Magstadt (DE)

(21) Appl. No.: 18/702,965

(22) PCT Filed: Sep. 19, 2022
(86) PCT No.: PCT/EP2022/075976

§ 371 Date: Apr. 19, 2024

(30) Foreign Application Priority Data
Oct. 22, 2021 (DE) 10 2021 005 277.3

(51) Int. Cl. B60R 25/25; B60R 25/30; G06V 20/59; G06V 40/16

(52) U.S. Cl. CPC B60R 25/25; B60R 25/305; G06V 20/59; G06V 40/172

(57) ABSTRACT

A user of a motor vehicle is authenticated using a camera arranged in the vehicle interior of the motor vehicle. The field of vision of the camera includes an internal region adjoining the driver's door in the vehicle interior and an external region adjoining the driver's door outside the motor vehicle, so that the authentication of the user can be or is implemented by comparing an image of the user generated by the camera when the user is still located in the external region, and thus outside the motor vehicle.

### BACKGROUND AND SUMMARY OF THE INVENTION

Exemplary embodiments of the invention relate to a method for authenticating the user of a motor vehicle and to a motor vehicle equipped/programmed to carry out this method.

In conventional methods, a user authentication for accessing a motor vehicle is generally implemented using an electronic key, by means of which the vehicle doors of the vehicle can be unlocked.

Authenticating by means of facial recognition is also known. Such facial recognition can be implemented by means of a camera installed in the vehicle interior, the camera generating an image in the vehicle interior, the image containing the face of the driver, so that the latter can be compared with a database. However, for this purpose, it is necessary that the driver has already obtained access to the vehicle, because the field of vision of the camera is limited to the vehicle interior.

Corresponding conventional methods are described in DE 2015 116 832 A1 and in DE 10 2017 110 251 A1.

Exemplary embodiments of the present invention are directed to new approaches to developing methods for authenticating users of motor vehicles.

The basis of the invention is accordingly to use a camera provided for interior monitoring in a vehicle interior of the motor vehicle for the user authentication. However, the camera is designed so that its field of vision comprises not only comprise the vehicle interior, but also a region of the external environment of the motor vehicle—described as an “external region” in the following—adjoining the driver's door on the outside. Unlike in conventional methods, facial recognition for a user of the vehicle who is still located outside the vehicle can thus be carried out by means of a camera equipped for interior monitoring, without the need for a separate exterior camera to generate images. Significant advantages with regard to cost when producing the motor vehicle are associated with this possibility for access authentication, which is convenient for the user of the vehicle.

In the method according to the invention for authenticating a user of a motor vehicle, the authentication is implemented by means of a camera located in the vehicle interior of the motor vehicle. The field of vision of the camera has an internal region adjoining the driver's door in the vehicle interior and an external region adjoining the driver's door outside the motor vehicle. The authentication of the user can thus be implemented by comparing an image of the user generated by means of the camera when the user is still located in the external region, and thus outside the motor vehicle. Consequently, it is also unnecessary for the user first to obtain access to the vehicle interior using an electronic key or the like so that they can then carry out the actual authentication by means of facial recognition. The provision of a separate camera to monitor the external region around the driver's door, and thus a region outside the motor vehicle, is thus not required. Instead, a camera that is provided in the vehicle interior can be used, the camera often already being provided as standard for vehicle interior monitoring—for example in connection with a so-called fatigue assistant or another vehicle assistance system of the motor vehicle.

In a preferred embodiment of the method according to the invention, the authentication is implemented by facial recognition, in which the face of the user recognized in the recorded image by means of image analysis is compared with stored reference images.

The invention further relates to a motor vehicle having a vehicle interior that is partially delimited by a driver's door. The motor vehicle according to the invention further has a camera for generating images, the field of vision of the camera comprising an internal region adjoining the driver's door in the vehicle interior and an external region adjoining the driver's door outside the motor vehicle. An image in the region of the driver's door can thus be recorded by means of the camera, wherein the image contains both a part of the vehicle interior and the exterior region of the motor vehicle in the region of the driver's door. In addition, the motor vehicle comprises a control/regulation device that is connected to the camera by a data link. Data relating to an image recorded by the camera, and thus in particular image data, of the camera's field of vision can thus be transmitted to the control/regulation device, and can be further processed by the latter to carry out the method according to the invention. The control/regulation device is thus also equipped/programmed to carry out the method according to the invention. The advantages previously explained of the method according to the invention consequently apply to the motor vehicle according to the invention.

In a preferred embodiment, the driver's door comprises a light-permeable windowpane, designed so that the external region can be recorded by the camera without distortion. In this way, it is ensured that faces contained in the images generated by the camera are reproduced correctly, in particular without imaging errors, so that the facial recognition is not negatively influenced.

Further important features and advantages of the invention result from the sub-claims, from the drawings and from the associated description of figures with reference to the drawings.

Naturally, the previously specified features and the features still to be explained in the following can be used not only in the respectively specified combination, but also in other combinations or in isolation without leaving the scope of the present invention.

Preferred embodiments of the invention are depicted in the drawings, and are explained in more detail in the following description, wherein identical reference numerals relate to identical or functionally identical components.

### BRIEF DESCRIPTION OF THE DRAWING FIGURES

Here, respectively schematically:

FIG. 1 shows an example of a motor vehicle according to the invention in a side view, and

FIG. 2 shows the motor vehicle of FIG. 1 in a schematically significantly simplified aerial view in the region of its driver's door.

### DETAILED DESCRIPTION

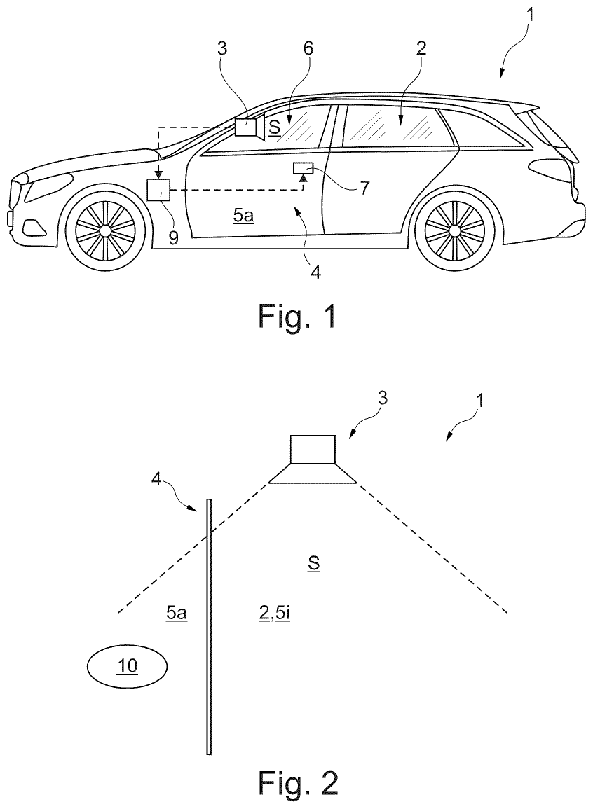

FIG. 1 shows an example of a motor vehicle 1 according to the invention in a side view. The motor vehicle 1 comprises vehicle interior 2, which is partially delimited by a driver's door 4. The motor vehicle 1 further comprises a camera 3 for generating images. As indicated in FIG. 1, the camera 3 can be arranged in the vehicle interior 2 in the region of the windscreen, and from there can be aligned into the vehicle interior 2. A field of vision S of the camera 3 comprises an internal region 5i adjoining the driver's door 4 in the vehicle interior 2 and an external region 5a adjoining the driver's door 4 outside the motor vehicle 1. The camera 3 is thus able to generate an image both of the external and of the internal region 5a, 5b. The driver's door 4 can comprise a light-permeable windowpane 6, which is designed so that the external region 5a can be recorded by the camera 3 without distortion. In this way, it is ensured that the image recorded by the camera 3 also reproduces the external region 5a without imaging errors, in particular without distortion.

The motor vehicle 1 additionally comprises a control/regulation device 9 connected to the camera 3 by a data link. The control/regulation device 9 is equipped and programmed to carry out the method according to the invention still to be explained in an exemplary form in the following. For this purpose, the control/regulation device 9 is connected to the camera 3 by a data link. Data, in particular image data, relating to images of the field of vision S recorded by the camera 3 can thus be transmitted from the camera 3 to the control/regulation device 9 and further processed by the latter in the course of the method according to the invention.

The method according to the invention is carried out using the camera 3. An image of a user 10 (see FIG. 2) of the motor vehicle 1 who is located in the external region 5a is recorded for this purpose and transmitted to the control/regulation device 9. Facial recognition can be carried out by the control/regulation device 9 by means of image analysis. The face of the user 10 recognized in the image is compared with reference faces of users with access authorization stored in a storage unit of the control/regulation device 9. If the result of this comparison is that the face of the user 10 recognized in the image matches one of the stored reference faces, then the authentication is rated successful. Consequently, a door lock 7 for locking the driver's door 4 can, for example, be unlocked by the control/regulation device 9, so that the user 10 can open the driver's door 4, get into the motor vehicle 1 and drive away with the motor vehicle 1. If authentication is unsuccessful, however, the driver's door 4 cannot be unlocked.

In one variant, the motor vehicle 1 can have a vehicle assistance system, which further processes that image of the internal region 5i of the vehicle interior 2 generated by the camera 3. Such a vehicle assistance system can, for example, be a so-called fatigue system, which can recognize signs of fatigue which may be present by analyzing the face of the driver recognized in the image, and, in the event that this is the case, generate a, for example, acoustic or optical warning signal to warn the driver. Thus, it is unnecessary to provide a separate camera 3 for the vehicle assistance system. Rather, the camera 3 can be used both to work together with one or several vehicle assistance systems of the motor vehicle 1 and to carry out the method according to the invention for user authentication.

Although the invention has been illustrated and described in detail by way of preferred embodiments, the invention is not limited by the examples disclosed, and other variations can be derived from these by the person skilled in the art without leaving the scope of the invention. It is therefore clear that there is a plurality of possible variations. It is also clear that embodiments stated by way of example are only really examples that are not to be seen as limiting the scope, application possibilities or configuration of the invention in any way. In fact, the preceding description and the description of the figures enable the person skilled in the art to implement the exemplary embodiments in concrete manner, wherein, with the knowledge of the disclosed inventive concept, the person skilled in the art is able to undertake various changes, for example, with regard to the functioning or arrangement of individual elements stated in an exemplary embodiment without leaving the scope of the invention, which is defined by the claims and their legal equivalents, such as further explanations in the description.

1-5. (canceled)

6. A method for authenticating a user of a motor vehicle, the method comprising:
capturing, by a camera arranged in a vehicle interior of the motor vehicle, an image of the user, wherein the camera has a field of view comprising an internal region adjoining a driver's door in the vehicle interior and an external region adjoining the driver's door outside the motor vehicle, wherein the user is located in the external region; and
authenticating the user based on at least the captured image of the user.

7. The method of claim 6, wherein the authenticating of the user involves facial recognition using image analysis by comparing a face of the user in the capture image by with stored reference images of the face of the user.

8. A motor vehicle comprising:
a vehicle interior partially delimited by a driver's door;
a camera configured to capture an image of a user of the motor vehicle, wherein the camera has a field of view comprising an internal region adjoining the driver's door in the vehicle interior and an external region adjoining the driver's door outside the motor vehicle;
a control/regulation device, coupled to the camera by a data link, configured to obtain data relating to the image captured by the camera,
wherein the user is located in the external region and the control/regulation device is configured to authenticate the user based on at least the captured image.

9. The motor vehicle of claim 8, wherein the driver's door comprises a light-permeable windowpane configured so that the external region is recordable by the camera without distortion.

10. The motor vehicle of claim 8, further comprising:
at least one vehicle assistance system configured to further process the internal region of the vehicle interior captured in the image.
